(19) United States
(12) Patent Application Publication
(10) Pub. No.: US 2024/0385293 A1
(43) Pub. Date: Nov. 21, 2024

(54) SOLID-STATE LIDAR DEVICE

(71) Applicant: Taiwan-Asia Semiconductor Corporation, Hsinchu City (TW)

(72) Inventors: Wei-Chen LIU, Taoyuan (TW); Sheng-Wei CHEN, Hsinchu City (TW)

(21) Appl. No.: 18/590,553

(22) Filed: Feb. 28, 2024

(30) Foreign Application Priority Data
May 19, 2023 (TW) 112118706

(51) Int. Cl. G01S 7/481

(52) U.S. Cl. CPC G01S 7/4811; G01S 7/4814; G01S 7/4816

(57) ABSTRACT

A solid-state lidar device includes an emitting module and a receiving module. The emitting module includes a laser driver and a light emitting source. The laser driver is used to drive the light emitting source to emit a light signal. The laser driver is a high electron mobility transistor, and the light emitting source includes at least one laser diode. The receiving module is used to receive the light signal being reflected and generate an output signal according to the light signal, and the receiving module includes an avalanche photodiode. The avalanche photodiode includes a lead sulfide quantum dot colloid layer, and the lead sulfide quantum dot colloid layer is arranged on a reflection path of the light signal received by the avalanche photodiode.

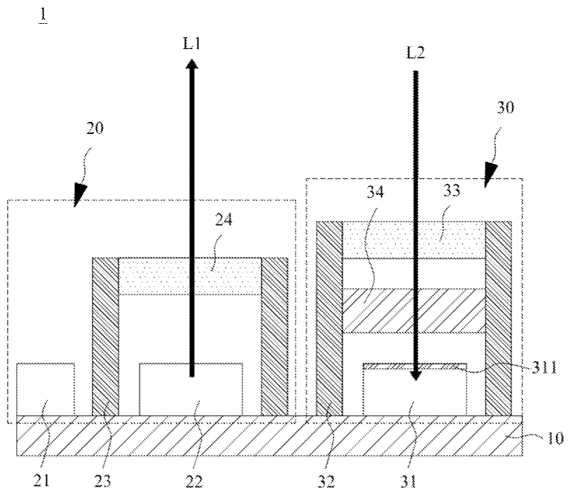

### CROSS-REFERENCES TO RELATED APPLICATIONS

This application claims priority to Taiwanese Patent Application No. 112118706 filed on May 19, 2023, which is hereby incorporated by reference in its entirety.

### BACKGROUND OF THE INVENTION

### Field of the Invention

The present invention relates to a solid-state lidar device, particularly a solid-state lidar device that can improve sensing performance.

### Descriptions of the Related Art

A light detection and ranging (lidar) device is a device that uses light waves directed at an object and receives reflected light from the object through an optical sensor to perform remote sensing of distance. With different structure designs, lidar devices can be roughly divided into mechanical lidars or solid-state lidars. Compared with mechanical lidars, solid-state lidars have the advantages of structure miniaturization and low cost. However, most conventional solid-state lidars use silicon-based photodiodes as laser drivers at the emitting end. The lower switching frequency of the silicon-based photodiodes causes a decrease in resolution and thus easily affects the determination accuracy of image sensing. In addition, most of the light emitting sources at the emitting end of the conventional solid-state lidars provide an operating wavelength around 905 nm, which not only easily causes harm to human eyes but also has more noise. Although the power of the light emitting sources is reduced according to the current safety regulations, it has caused the effective sensing distance to be reduced and other problems.

Besides, most conventional solid-state lidar devices use general photodiodes as light sensors at the receiving end. However, if the photodiodes are silicon-based, their response efficiency to light with wavelengths greater than 1000 nm is poor. Even if the photodiodes are gallium indium arsenide-based, which has better response efficiency to light with a wavelength greater than 1000 nm, the material is expensive, and the manufacturing cost is increased.

Therefore, it is worthwhile to study how to design a solid-state lidar device that can solve the above problems.

### SUMMARY OF THE INVENTION

The objective of the present invention is to provide a solid-state lidar device that can improve sensing performance.

To achieve the above objective, the solid-state lidar device of the present invention includes an emitting module and a receiving module. The emitting module includes a laser driver and a light emitting source. The laser driver is used to drive the light emitting source to emit a light signal. The laser driver is a high electron mobility transistor, and the light emitting source includes at least one laser diode. The receiving module is used to receive the light signal being reflected and generate an output signal according to the light signal, and the receiving module includes an avalanche photodiode. The avalanche photodiode includes a lead sulfide quantum dot colloid layer, and the lead sulfide quantum dot colloid layer is arranged on a reflection path of the light signal received by the avalanche photodiode.

In an embodiment of the present invention, the laser driver provides a switching frequency ranging between 10 kHz and 10 MHz.

In an embodiment of the present invention, the high electron mobility transistor is gallium nitride-based.

In an embodiment of the present invention, at least one laser diode provides an operating wavelength range between 1400 nm and 1600 nm.

In an embodiment of the present invention, the emitting module further includes a first optical lens, and the first optical lens is arranged on an emission path of the light signal emitted by the light emitting source.

In an embodiment of the present invention, the receiving module further includes a receiving optical lens, and the receiving optical lens is arranged on the reflection path of the light signal received by the avalanche photodiode.

In an embodiment of the present invention, the receiving module further includes an optical filter arranged on the reflection path of the light signal received by the avalanche photodiode and located between the avalanche photodiode and the receiving optical lens.

In an embodiment of the present invention, the solid-state lidar device further includes a substrate, and the emitting module and the receiving module are both disposed on the substrate.

Accordingly, the solid-state lidar device of the present invention uses gallium nitride-based high electron mobility transistors to increase the switching frequency of the laser driver and uses an emitted light source with a higher operating wavelength to reduce the harm to human eyes and maintain an effective sensing distance. In addition, the sensing sensitivity and the absorption of short-wave infrared rays can also be improved by the configuration of the combination of avalanche photodiodes and lead sulfide quantum dot colloid layers.

### BRIEF DESCRIPTION OF THE DRAWINGS

The FIGURE is a schematic view of the solid-state lidar device of the present invention.

### DETAILED DESCRIPTION OF THE PREFERRED EMBODIMENT

Since the various aspects and embodiments are merely illustrative and not restrictive, after reading this specification, a person having ordinary skill in the art may also have other aspects and embodiments without departing from the scope of the present invention. The features and advantages of these embodiments and the scope of the patent application will be better appreciated from the following detailed description.

Herein, “a” or “an” is used to describe one or more devices and components described herein. Such a descriptive term is merely for the convenience of illustration and to provide a general sense of the scope of the present invention. Therefore, unless expressly stated otherwise, the term “a” or “an” is to be understood to include one or at least one, and the singular form also includes the plural form.

Herein, the terms “first” or “second” and similar ordinal numbers are mainly used to distinguish or refer to the same or similar devices or structures, and do not necessarily imply the spatial or temporal order of such devices or structures. It should be understood that in certain situations or configurations, ordinal numbers may be used interchangeably without affecting the practice of the present invention.

As used herein, the term “comprise” “include,” “have” or any other in similar term is not intended to exclude additional, unrecited elements. For example, a device or structure comprising/including/having a plurality of elements is not limited to the elements listed herein but may comprise/include/have other elements not explicitly listed but generally inherent to the device or structure.

Reference is made to the FIGURE, which is a schematic view of the solid-state lidar device of the present invention. As shown in the FIGURE, the solid-state lidar device 1 of the present invention includes a substrate 10, an emitting module 20 and a receiving module 30. The substrate 10 mainly serves as a basic structure for relevant electronic components and/or structural members of the solid-state lidar device 1 of the present invention to be arranged thereon. In the present invention, the substrate 10 may be a BT resin substrate, an epoxy resin substrate (e.g., an FR4 substrate), or a ceramic substrate. However, the material of the substrate 10 may be changed according to different design requirements.

The emitting module 20 is disposed on the substrate 10. The emitting module 20 mainly includes a laser driver 21 and a light emitting source 22. The laser driver 21 is electrically connected to the light emitting source 22. The laser driver 21 is used to drive the light emitting source 22 to emit a light signal. The laser driver 21 is a high electron mobility transistor (HEMT). In an embodiment of the present invention, the laser driver 21 provides a switching frequency ranging between 10 kHz and 10 MHz. In the present invention, to achieve the aforementioned switching frequency, the high electron mobility transistor employed for the laser driver 21 is gallium nitride-based (GaN-based). However, other transistors that can achieve similar or higher switching frequencies may also be used as the base material of the high electron mobility transistor, and the present invention is not limited thereto. The GaN-based high electron mobility transistor can provide lower on-resistance and charging capacitance than the silicon-based high electron mobility transistors. These characteristics increase the switching frequency and the sensing accuracy.

The emitting light source 22 is used to emit a light signal. In the present invention, the light emitting source 22 includes at least one laser diode. For example, the emitting light source 22 may use a single laser diode or a laser diode array composed of a plurality of laser diodes. The aforementioned laser diode may be a vertical-cavity surface-emitting laser (VCSEL). However, depending on the design requirements, the aforementioned laser diode may also be an edge-emitting laser (EEL), and the present invention is not limited thereto.

In an embodiment of the present invention, the emitting light source 22 provides an operating wavelength range between 1400 nm and 1600 nm. For example, the emitting light source 22 may provide the operating wavelength of 1550 nm, but the present invention is not limited thereto. Since the aforementioned operating wavelength range is greater than 1400 nm and conforms to the human eye-safe spectrum, the light signal emitted by the emitting light source 22 is less likely to be focused on the retina of the human eye so as to minimize the harm to the human eye. Accordingly, the present invention can further increase the power of the emitting light source 22 of the emitting module 20 to increase the sensing distance of the solid-state lidar device 1 of the present invention.

In an embodiment of the present invention, the emitting module 20 further includes a first barrier structure 23. The first barrier structure 23 is a hollow structural member. One end of the first barrier structure 23 is connected to the substrate 10, and the other end of the first barrier structure 23 forms an open end having an aperture. The first barrier structure 23 is provided around the emitting light source 22 to block the light signal emitted by the emitting light source 22 from being scattered laterally and concentrated toward the aperture. The first barrier structure 23 is made of non-transparent epoxy resin, e.g., encapsulating black resin, but the present invention is not limited thereto.

In an embodiment of the present invention, the emitting module 20 further includes a first optical lens 24. The first optical lens 24 is arranged on the emission path L1 of the light signal emitted by the light emitting source 22 (e.g., the aperture position of the open end of the first barrier structure 23) such that the first optical lens 24 is located directly above the light emitting source 22. In the present invention, the first optical lens 24 is made of light-transmissive glass or plastic material, but the present invention is not limited thereto.

The receiving module 30 is disposed on the substrate 10. The receiving module 30 is used to receive the light signal reflected by the sensed object and to generate an output signal based on the light signal for subsequent sensing processing. The receiving module 30 includes an avalanche photodiode (APD) 31. In the present invention, to increase the response intensity of the avalanche photodiode 31 to short wave infrared (SWIR), the avalanche photodiode 31 includes a lead sulfide quantum dot (PbS QD) colloid layer 311. The lead sulfide quantum dot colloid layer 311 is arranged on the reflection path L2 of the light signal received by the avalanche photodiode 31 (e.g., the lead sulfide quantum dot colloid layer 311 may be disposed on the surface or in the structure of the avalanche photodiode 31, which receives the light signal). Since the avalanche photodiode 31 has higher sensitivity than general photodiodes, and the light-sensing spectrum of the lead sulfide quantum dot colloid layer 311 covers 1400 nm to 1600 nm, it is helpful for the absorption of short-wave infrared rays so that the avalanche photodiode 31 improves the response intensity to short-wave infrared.

In an embodiment of the present invention, the receiving module 30 further includes a second barrier structure 32. The second barrier structure 32 is a hollow structural member. One end of the second barrier structure 32 is connected to the substrate 10, and the other end of the second barrier structure 32 forms an open end having an aperture. The second barrier structure 32 is provided around the avalanche photodiode 31 to block the noise light incident from the side and to concentrate the light signal reflected by the object toward the aperture to be received by the avalanche photodiode 31. The second barrier structure 32 is made of non-transparent epoxy resin, e.g., encapsulating black resin, but the present invention is not limited thereto.

In an embodiment of the present invention, the receiving module 30 further includes a second optical lens 33. The second optical lens 33 is arranged on the reflection path L2 of the light signal received by the avalanche photodiode 31 (e.g., the aperture position of the open end of the second barrier structure 32) such that the second optical lens 33 is located directly above the avalanche photodiode 31. In the present invention, the second optical lens 33 is made of light-transmissive glass or plastic material, but the present invention is not limited thereto.

In an embodiment of the present invention, the receiving module 30 further includes an optical filter 34. The optical filter 34 is also arranged on the reflection path L2 of the light signal received by the avalanche photodiode 31 (e.g., the optical filter 34 is located between the avalanche photodiode 31 and the second optical lens 33 and within the second barrier structure 32) so that the light signal passing through the second optical lens 33 must pass through the optical filter 34 before being received by the avalanche photodiode 31 to produce a filtering effect on the light signal. In the present invention, the optical filter 34 is made of light-transmissive glass, sapphire or magnesium oxide (MgO) material, and the light filtering spectrum provided by the optical filter 34 will change with different design requirements, but the present invention is not limited thereto.

In operation, the solid-state lidar device 1 of the present invention first drives the emitting light source 22 through the laser driver 21 of the emitting module 20 so that the emitting light source 22 emits a light signal. The light signal will pass through the first optical lens 24 along the emission path L1 to leave the emitting module 20 until it reaches the location of the sensed object. Then, after being reflected by the sensed object, the light signal will enter the receiving module 30 along the reflection path L2, pass through the second optical lens 33 and the optical filter 34 in sequence, and then reach the avalanche photodiode 31 so that the avalanche photodiode 31 receives the light signal and generates an output signal according to the light signal. Therefore, the solid-state lidar device 1 of the present invention can effectively achieve the signal transmission effect between the high voltage area and the low voltage area through light transmission.

Accordingly, the solid-state lidar device 1 of the present invention can integrate the emitting module 20 and the receiving module 30 on the same substrate 10, and increase the switching frequency of the laser driver by using the GaN-based high electron mobility transistor to obtain better sensing resolution. Using an emitting light source with an operating wavelength of no less than 1400 nm not only reduces the harm to the environment and human eyes but also maintains high-power operation to improve effective sensing distance. In addition, the sensing sensitivity and the absorption of short-wave infrared rays can also be improved by the configuration of the combination of avalanche photodiodes and lead sulfide quantum dot colloid layers, and the cost can be reduced.

The foregoing detailed description is illustrative in nature only and is not intended to limit the embodiments of the claimed subject matters or the applications or uses of such embodiments. Furthermore, while at least one exemplary embodiment has been presented in the foregoing detailed description, it should be appreciated that a wide variety of modifications to the present invention are possible. It should also be appreciated that the embodiments described herein are not intended to limit the scope, use, or configuration of the claimed subject matters in any way. Instead, the foregoing detailed description is intended to provide a person having ordinary skill in the art with a convenient guide for implementing one or more of the described embodiments. Moreover, various modifications may be made in the function and arrangement of the devices without departing from the scope defined by the claims, including known equivalents and any equivalents that may be anticipated at the time of filing this patent application.

What is claimed is:

1. A solid-state lidar device, comprising:
an emitting module, comprising a laser driver and a light emitting source, the laser driver being configured to drive the light emitting source to emit a light signal, wherein the laser driver is a high electron mobility transistor, and the light emitting source comprises at least one laser diode; and
a receiving module, being configured to receive the light signal being reflected and generate an output signal based on the light signal, and the receiving module comprising an avalanche photodiode; wherein the avalanche photodiode comprises a lead sulfide quantum dot colloid layer and the lead sulfide quantum dot colloid layer is arranged on a reflection path of the light signal received by the avalanche photodiode.

2. The solid-state lidar device of claim 1, wherein the laser driver provides a switching frequency ranging between 10 kHz and 10 MHz.

3. The solid-state lidar device of claim 2, wherein the high electron mobility transistor is gallium nitride-based.

4. The solid-state lidar device of claim 1, wherein the emitted light source provides an operating wavelength range between 1400 nm and 1600 nm.

5. The solid-state lidar device of claim 1, wherein the emitting module further comprises a first optical lens, and the first optical lens is arranged on an emission path of the light signal emitted by the light emitting source.

6. The solid-state lidar device of claim 1, wherein the receiving module further comprises a receiving optical lens, and the receiving optical lens is arranged on the reflection path of the light signal received by the avalanche photodiode.

7. The solid-state lidar device of claim 6, wherein the receiving module further comprises an optical filter arranged on the reflection path of the light signal received by the avalanche photodiode and located between the avalanche photodiode and the receiving optical lens.

8. The solid-state lidar device of claim 1, further comprising a substrate, on which the emitting module and the receiving module are disposed.
